(19) United States
(12) Patent Application Publication
(10) Pub. No.: US 2008/0294529 A1
(43) Pub. Date: Nov. 27, 2008

(54) Method and system for delivering a purchase receipt

(76) Inventors: Jari Niemi, Turku (FI); Tomi Saari, Raisio (FI)

Correspondence Address: NIXON & VANDERHYE, PC, 901 NORTH GLEBE ROAD, 11TH FLOOR, ARLINGTON, VA, 22203, US

(21) Appl. No.: 11/802,777

(22) Filed: May 24, 2007

(51) Int. Cl. G06Q 30/00

(52) U.S. Cl. 705/26

(57) ABSTRACT

The invention concerns a new way for ordering, drafting, paying and delivering a purchase receipt (1), such as a gift certificate or an entrance ticket, electronically and in real time.

### TECHNICAL FIELD RELATING TO THE INVENTION

The invention concerns a new way for ordering, drafting, paying and delivering electronically a purchase receipt, such as a gift certificate or an entrance ticket, according to the preambles of the independent claims presented below.

### PRIOR ART

It is known to order and to deliver gift certificates, entrance tickets and corresponding purchase certificates through the internet or another data network, which purchase receipt the recipient can use when buying the services or products offered by a service provider. Typically, an order made by an orderer of a purchase receipt and a notification of a payment or a number of a credit card arrive to a service provider, a travel agency, a ticket dealer or the like. He then prints out the information he has received or otherwise enters the order into his system after having ensured the validity of the payment or the credit card.

A problem with traditional purchase receipts is that they and their physical appearance have not been able to be tailored according to the needs of the orderer, the service provider or the recipient of the purchase receipt. In addition, a problem has been that in the order and delivery chain of a purchase receipt, there have always been stages that require handwork. Furthermore, earlier, the whole chain from the order to the arrival of the purchase receipt to its recipient has not been available in electronic form.

### SUMMARY OF THE INVENTION AND ITS PREFERRED EMBODIMENTS

It is an object of the present invention to provide a system and a method and a computer software product that minimize the above-mentioned problems of the prior art.

An object of the invention is especially to provide a way to produce exclusive purchase receipts, such as gift certificates and entrance tickets, in a more efficient and easier way than before. An object is especially that the needs of as well the orderer of the purchase receipt, the service provider as the recipient of the purchase receipt can be taken into account better than earlier when delivering the purchase receipt.

The above-mentioned drawbacks can be removed, or they are reduced and the above-mentioned objects are achieved by a system, a method and a computer software product according to the invention, characterized by what is defined in the characterizing parts of the independent claims presented below. The dependent claims present some preferred embodiments of the invention.

The application examples and advantages mentioned herein apply in applicable parts as well to each system according to the invention, all methods according to the invention, as to computer software products according to the invention, even if it is not specifically mentioned.

By orderer of the purchase receipt is meant herein for example a buyer of a gift certificate or an entrance ticket, by service provider is meant for example a hotel, a travel agency, an airline company or an organizer of a sports event, an art exhibition or some other company or dealer selling services or products. By recipient of a purchase receipt is meant a party intended as the recipient of the gift certificate, entrance ticket or another corresponding item. Electronic data group means one or more databases, parts of a database, files, parts of a file or other corresponding means wherein data can be stored in electronic form. An example of this is a hotel reservation database or a seat reservation system of a concert hall. Means for entering, maintaining and removing a data group or the data contained in it are typically computers, servers or terminal devices and telecommunication connections between them, known in the prior art. Said means comprise typically also various computer software and computer programs, the execution of which for example performs entering, maintenance and removal of said data. Means typically also comprise a user interface by means of which a user controls the functioning of the system. The interface is typically electronic and realized by a software, for example on a computer screen, controlled by means of a mouse or the like. By data structure is meant herein a structure, appropriate for each purpose, for representing data for example the name, address, logo or another identifier of the orderer of the purchase receipt, the service provider or the recipient of the purchase receipt, or the name or another identifier of the product or service to be provided by means of a purchase receipt. A portable communication means herein means for example a portable computer, a mobile phone or a PDA device (Personal Digital Assistant).

The invention can also be realized in the form of a computer software product, whereby the computer software in question comprises the program code elements required for performing the stages of the method according to the invention, when the program is run on a computer. According to the invention, the computer software product can be stored on a memory means or it can be a group of electronic data moving in a telecommunication device.

One major advantage of the invention is that it allows to draft, to send, and to pay for a unique purchase receipt tailor-made according to the needs of the orderer of the purchase receipt, the service provider and/or the recipient of the purchase receipt, and to receive a completed purchase receipt, as well as to eventually forward it quickly, easily and economically. The invention enables to place identifiers selected by the orderer of the purchase receipt, such as logos or other pictures, private or individual greetings or other messages, onto the purchase receipt. The invention also allows for the service provider a simple way to select the desired data to the purchase receipts used in the provision of their products or services.

One major advantage of the invention is that it allows sending the final purchase receipt in electronic form to the recipient of the purchase receipt immediately after the order. The recipient can print out e.g. at home the gift certificate arriving to his e-mail for example as a pdf file.

The preferred method according to the invention is performed at least partly wirelessly. For example, the orderer of the purchase receipt can make the order, the tailoring of the purchase receipt and the payment from a wireless terminal device. It is also possible to send the purchase receipt to the wireless terminal device of its recipient.

Typically, the telecommunications required by the invention are handled through the internet or a corresponding data network. The system according to the invention then comprises a terminal device of internet or another corresponding data network and/or a portable communication means that the orderer of the purchase receipt uses while making the order. Such device typically comprises an internet user interface or the like, by means of which the selection of the purchase receipt and the data structures to be attached to it is arranged to be made. The telecommunications between the user interface and the data group required for these operations, i.e. a database containing for example the booking situation of a hotel, is then communicated for example along a wireless signal system or the internet or a corresponding data network.

### BRIEF DESCRIPTION OF THE FIGURES

In the following, the invention is described more in detail with reference to the enclosed drawing, in which:

FIG. 1 shows schematically a gift certificate according to the invention to which identifiers of the service provider have been attached,

FIG. 2 shows schematically the gift certificate of FIG. 1 to which tailor-made data have been attached.

### DETAILED DESCRIPTION OF PREFERRED EMBODIMENTS

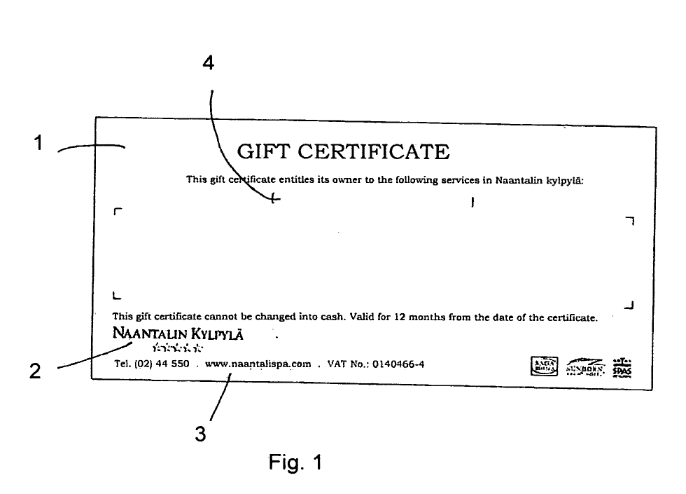

FIG. 1 shows an electronic gift certificate template 1 of a service provider. The data that the service provider wishes to have in the gift certificate intended for providing their services are marked to the gift certificate template 1. Onto the certificate, i.a. the logo 2 and contact details 3 of the service provider are marked. It is possible that the service provider has access to an internet user interface in which he can design the electronic template of a gift certificate to look as desired.

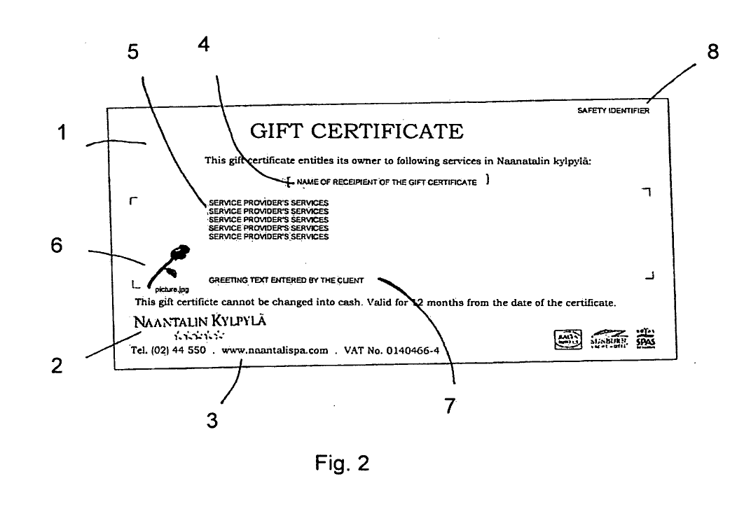

When the orderer of the gift certificate accesses the internet pages of the service provider, he can, if desired, open an orderer's user interface wherein it is possible to select the data concerning the recipient of the gift certificate or other data selected by the orderer, to be attached to the gift certificate. FIG. 2 shows how fields into which the orderer can select certain things are placed on an electronic template 1 of a gift certificate to be presented in the internet by means of the orderer's user interface. For example, the orderer can place onto the gift certificate the name of the recipient into field 4, the identifiers of the services bought and attached to the gift certificate into field 5, a picture, for example a logo of the orderer's company into field 6, and a free greeting text into field 7.

By means of an orderer's user interface it is also possible to make the payment of the gift certificate. When the payment is made and the data concerning the products or services ordered is forwarded via the data network, for example to a service provider, the system according to the invention adds a check identifier, for example a bar code or a number series that is used for identifying the gift certificate 1 and the services contained in it when the gift certificate is being used., to field 8 of the electronic template of the gift certificate.

By means of the system according to the invention it is thus possible that the orderer places an order of a purchase certificate that is made and paid in real time. The system can also receive the data and the graphical material given by the client and place them into the electronic gift certificate in the way the orderer desires them to be shown in the gift certificate. The system can receive a payment from the orderer in real time, for example by means of an internet bank connection. The system can form and send to the service provider the identifier for the payment it has received. The system can form a check identifier representing the payment and the services or products ordered and place it to an electronic purchase receipt template. The system can simultaneously activate the order to the service provider's system. The system can receive information from the service provider on the success of the order. The system can also send a completed purchase receipt to its recipient for example by e-mail to the address defined by the orderer. The recipient can print out the graphically finished purchase certificate that is ready for use or forward it to the final user for printing.

One application of the method according to the invention comprises at least the following stages. It is clear that within the inventive idea one or more of the following stages can be left out or replaced by something else:
a service provider is selected,
a background picture of a purchase certificate, for example a gift certificate, is selected from the selection prepared by the service provider
an orderer enters the desired data
it is ensured that all necessary data, such as the name of the recipient or another identifier is entered
the data entered by the orderer, for example the data concerning the payer, the data concerning the recipient of the gift certificate, the own pictures, logos and greeting texts of the orderer, are stored,
real time payment of the purchase certificate, such as a gift certificate, is made for example by a bank card, a credit card, or a so-called mobile payment method,
a safety identifier of the purchase certificate is formed and it is placed onto the purchase certificate,
the necessary data, for example the selected services of the service provider, the data concerning the recipient of the gift certificate, the pictures, the logos and greeting texts, is attached to the template of the service provider,
the purchase receipt to be sent, for example a pdf file, is formed,
the purchase receipt is sent in real time to the orderer for example by e-mail, by fax, or by means of a multimedia SMS,
the purchase receipt is activated to the operative system of the service provider.

It is obvious to a man skilled in the art that the invention is not limited merely to the above-described examples but the invention may vary within the scope of the claims presented below. In the dependent claims, some possible embodiments of the invention are presented and they should not be construed as limiting the scope of the invention.

1. Method for delivering a purchase receipt by an orderer of a purchase receipt to a recipient of the purchase receipt, in which method data structures representing products or services offered by one or more service providers and an electronic template representing the purchase receipt, in which template there are fields for presenting the data needed for the purchase receipt, are maintained in an electronic data group, characterized in that by means of an electronic user interface
a service provider is selected,
a data structure representing the purchase receipt (1) to be ordered, provided by the selected service provider, is retrieved from said electronic data group,
the data structure representing the purchase receipt (1 ) to be ordered is maintained under processing,
one or more data structures (5) representing products or services offered by the service provider is selected,
the selected one or more data structures (5) representing products or services offered by the service provider is placed to the data structure representing the purchase receipt (1) to be ordered,
one or more data structures (4, 6) representing he recipient of the purchase receipt (1) to be ordered and/or the orderer of the purchase receipt (1) to be ordered is selected,
the selected one or more data structures (4, 6) representing the recipient of the purchase receipt (1) to be ordered and/or the orderer of the purchase receipt (1) to be ordered is placed to the data structure representing the purchase receipt (1) to be ordered,
a payment is effected for the products or services offered by the service provider that are selected and placed to the data structure representing the purchase receipt (1) to be ordered,
a check identifier (8) that is placed to the data structure representing the purchase receipt (1) to be ordered is generated on the basis of the payment and the paid products,
an electronic document representing the purchase receipt (1) to be ordered is formed on the basis of the data structure representing the purchase receipt (1) to be ordered, and
the electronic document representing the purchase receipt (1) to be ordered is sent via an electronic data network to the address defined by the orderer of the purchase receipt.

2. Method according to claim 1, characterized in that the selected one or more data structures (5) representing products or services offered by the service provider are placed over an electronic data network from the terminal device of the orderer of the purchase receipt to the data structure representing the purchase receipt (1) to be ordered.

3. Method according to claim 1, characterized in that
a graphical data structure (6) representing the orderer of the purchase receipt is placed over an electronic data network from the terminal device of the orderer of the purchase receipt to the data structure representing the purchase receipt (1) to be ordered.

4. Method according to claim 1, characterized in that in an electronic data group, the selection of one or more data structures representing products or services offered by a service provider and placing them to a data structure representing the purchase receipt (1) to be ordered is performed on an internet terminal and/or on a portable communication means so that the telecommunication between the user interface and the data group, required by these operations, is communicated along a wireless signal system or the internet or a corresponding data network.

5. Computer software product, comprising one or more computer programs in operational connection to one other, which program(s) comprise program code elements that are arranged, when executing the program(s), to perform at least the stages of the method according to claim 1.

6. System for delivering a purchase receipt by an orderer of the purchase receipt to a recipient of the purchase receipt, the system comprising
means for representing data structures, representing the products or services offered by one or more service providers, and a template, representing the electronic purchase receipt to be ordered and containing fields for the data needed in the purchase receipt to be ordered, and for keeping them in an electronic data group,
means for feeding, maintaining and removing said electronic data group or the data contained in it,
characterized in that the system further comprises means for performing the stages of the method according to claim 1.

7. System according to claim 6, characterized in that it comprises an internet terminal or another corresponding data network terminal and/or a user interface to be presented on a display device of a portable communication means, by means of which the means comprised in the system are arranged to be used.

8. System according to claim 7, characterized in that it comprises means for communicating the telecommunication between a user interface and said electronic data group via a wireless signal system or internet or a corresponding data network.
